(19) United States
(12) Patent Application Publication
(10) Pub. No.: US 2020/0171691 A1
(43) Pub. Date: Jun. 4, 2020

(54) CUTTING MODULES

(71) Applicant: Hewlett-Packard Development Company, L.P., Houston, TX (US)

(72) Inventors: Martin Urrutia Nebreda, Sant Cugat del Valles (ES); Isabel Sanz Ananos, Sant Cugat del Valles (ES); Servando F Rodriguez Pablos, Sant Cugat del Valles (ES)

(73) Assignee: Hewlett-Packard Development Company, L.P., Houston, TX (US)

(21) Appl. No.: 16/074,391

(22) PCT Filed: Apr. 7, 2016
(86) PCT No.: PCT/US2016/026450

§ 371 Date: Jul. 31, 2018

(51) Int. Cl. B26D 1/24; B26D 1/18; B26D 5/02; B41J 11/70

(52) U.S. Cl. CPC B26D 1/245; B41J 11/70; B26D 5/02; B26D 1/185

(57) ABSTRACT

In an example, a cutting module may include a housing to engage the cutting module with a drive shaft, a cutter disposed in the housing, and a drive system to drive the cutter such that the cutter cuts media along a media path of an imaging device. The cutting module may move along the drive shaft laterally to the media path.

### BACKGROUND

Imaging systems may print, scan, copy, or perform other actions or operations with media. Further, imaging systems may include feeding or picking systems to load the media and deliver or drive the media through the imaging system for performing operations on or with the media. The imaging systems may scan the media for markings or patterns, deposit printing fluid, such as ink or another printing substance, on the media, and/or may produce duplicates of the media, including markings or patterns thereon, in addition to other functions.

### BRIEF DESCRIPTION OF THE DRAWINGS

FIG. 1A is a perspective view of an example cutting module.

FIG. 1B is a perspective view of an example cutting module.

FIG. 1C is a perspective view of an example imaging device including an example cutting module.

FIG. 2A is a perspective view of an example cutting module.

FIG. 2B is a side view of an example cutting module.

FIG. 2C is a side view of an example cutting module.

FIG. 3A is a perspective view of an example imaging device including an example cutting module.

FIG. 3B is a front view of an example imaging device including an example cutting module.

FIG. 3C is a front view of an example imaging device including an example cutting module.

### DETAILED DESCRIPTION

Imaging systems may include scanning systems, copying systems, printing or plotting systems, or other systems that perform actions or operations on or with media, sometimes referred to as print media. Imaging systems may deposit printing fluid, such as ink, or another printing substance, on media. The imaging system may deposit printing substance on media that is fed through the imaging system from a roll of media. In other situations, the media may be picked from a stack or ream of media for use in the imaging system, or media may be fed into the imaging system one sheet at a time. In some situations, the media may be three-dimensional (3D) print powder of a 3D printer, to be deposited on a print target or bed. In some situations, the media may be of a different size than the area to be printed, scanned, or copied in the imaging device. In such a situation, it may be desirable to cut or trim the media before or after the imaging system has performed the desired action upon the media. In some situations, it may be desirable to cut or trim the media to an appropriate size after the imaging device has deposited printing substance on the media.

In some situations, media may be pre-cut before being loaded into the imaging device, or the media may be removed from the imaging device to be cut or trimmed to an appropriate size during a finishing operation after media undergoes an action or operation within the imaging device. In some situations, the media may be manually trimmed or cut down to an appropriate size either before loading, or after removal from the imaging device. Such an operation can be labor-intensive, time-intensive, and/or expensive. Further, in some situations, the media may be removed from the imaging device and loaded into another device in order for the other device to cut or trim the media to an appropriate size. This type of finishing process or operation, utilizing a separate machine or device to cut the media, can also be labor-intensive, time-intensive, and/or expensive.

Implementations of the present disclosure provide a cutting module or device, or a cutting system that may cut media within an imaging device. This may avoid pre-cutting the media prior to being loaded into the imaging device, and may also avoid cutting the media after removal from the imaging device, in a finishing operation. Implementations of the present disclosure, being integrated with the imaging device, may avoid additional time and labor costs associated with cutting or trimming media to an appropriate size. The cutting module may be integrated with the imaging device so as to improve accuracy of cuts made to the media. For example, the imaging device can accurately cut along a desired path, or cut along an edge of a printed area, for example, because the imaging device possesses data including the location of edges of an area to be printed, or have another operation performed upon. In some implementations, an example cutting module, cutting device, or cutting system, may be disposed within an imaging device such that the cutting module may cut media to an appropriate size after the imaging device performs a desired action on the media. In other implementations, the cutting module may cut media to an appropriate size before the imaging device performs the desired action.

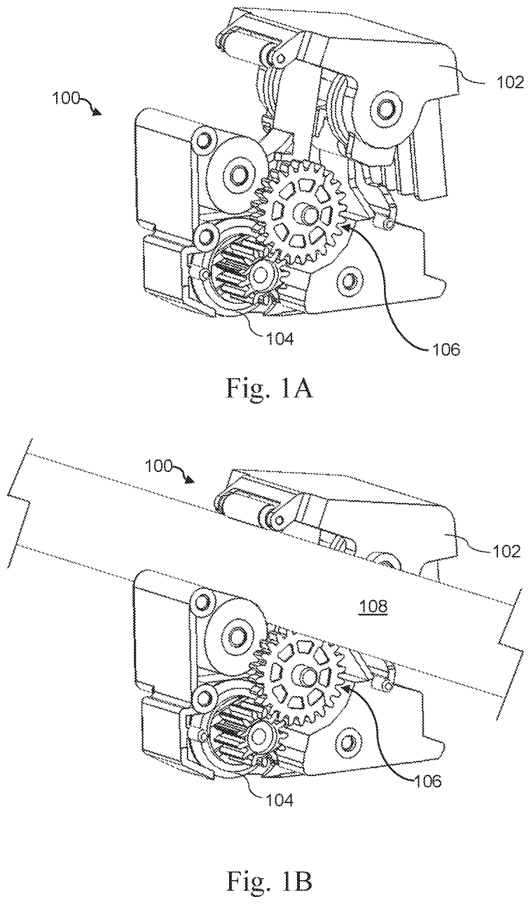

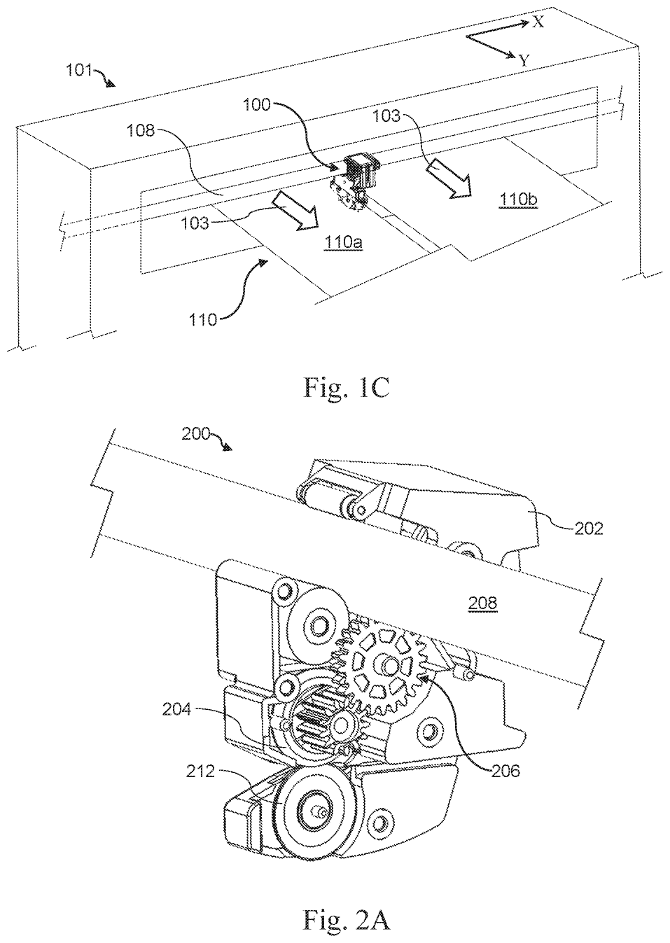

Referring now to FIG. 1A, a perspective view of an example cutting module 100 is illustrated. The cutting module 100 may include a housing 102, a cutter 104, and a drive system 106. Referring additionally to FIG. 1B, a perspective view of an example cutting module 100 is illustrated, wherein the cutting module 100 is engaged with a support shaft, or, in some implementations, a drive shaft 108. The drive shaft 108 may be a part of an imaging device in some implementations, or be a part of the cutting module 100, in other implementations. In some implementations, the housing 102 may be a rigid or semi-rigid frame or other structure to partially or wholly enclose and/or support some or all of the components of the cutting module 100. In some implementations, the housing 102 may engage the cutting module 100 with the support or drive shaft 108. In further implementations, the cutting module 100, when engaged with the drive shaft 108, may move along the drive shaft 108. The cutting module 100 may move along a longitudinal axis of the drive shaft 108, in some implementations. In further implementations, the housing 102 may engage with the drive shaft 108 by hanging from a circumference or outer surface of the drive shaft 108. Additionally, the cutting module 100, or the housing 102 thereof, in some implementations, may include a roller or rollers to engage with the drive shaft 108 such that the drive shaft 108 may rotate, about its longitudinal axis, relative to the cutting module 100.

The cutter 104 may be a component that is structured such that it may cut media. Such media may include paper, cardboard, cardstock, latex, vinyl, or other media suitable for use in an imaging system. The cutter 104 may be disposed partially or wholly within the housing, in some implementations, or supported thereby, or mounted thereon, in other implementations. In some implementations, the cutter 104 may have a sharp cutting edge, or knife edge with which the cutter 104 may cut media. In some implementations, the cutter 104 may be round, or a rotary cutter, wherein the cutter 104 is to cut media by rotating with media moving past the cutting module 100. In other implementations, the cutter 104 may have a straight cutting edge that may cut media when the media is moved against and past the straight cutting edge, in a similar fashion to a knife blade.

The drive system 106 may be a component or system capable of driving or actuating the cutter 104 such that the cutter 104 cuts media. The drive system 106 may include drive wheels, cogs, teeth, pulleys, belts, or other suitable mechanical or electro-mechanical components. In some implementations, the drive system 106 may be a transmission for transmitting rotational motion from a rotating component to the cutter 104, such that the cutter 104 rotates to cut media. In other implementations, the drive system may be a motor, or may be engaged with a motor, or another electrical component capable of driving the cutter 104.

Referring now to FIG. 1C, a perspective view of an example imaging device 101 including an example cutting module 100, is illustrated. The example imaging device 101 may be a printer, plotter, 3D printer, scanner, copier, press, labeler, or other device or system that may perform an action or operation upon media, or print media. In some implementations, the imaging device 101 may receive media from a roll. In other implementations, the imaging device may receive media from a stack or ream, or receive one individual piece of media at a time. In some implementations, the imaging device 101 may pick media 110, drive media 110, or deliver media 110 through a media path of the imaging device 101 such that the imaging device performs an operation on the media, and may then output the media 110 through the media path to exit the imaging device, and be retrieved by a user. In the example illustrated in FIG. 1C, the media path may be represented by arrows 103, aligned with a Y-direction.

The imaging device 101 may include an example cutting module 100. In some implementations, the cutting module 100 may be disposed within the media path 103 of the imaging device 101. In some implementations, the cutting module 100 may be installed by a user of the imaging device 101. In further implementations, the cutting module 100 may be installed by a user clipping the cutting module 100 onto, or hanging the cutting module 100 from the drive shaft 108. In some implementations, the drive shaft 108 may extend laterally into or across the media path 103 of the imaging device 101 to dispose the cutting module 100 in the media path 103. In further implementations, the drive shaft 108 may extend laterally across the media path so that the drive shaft 108 is substantially aligned with an X-direction, normal to or orthogonal to the Y-direction. In this context, the term substantially aligned with the X-direction may refer to the disposition of the drive shaft 108 being such so that the cutting module 100 may move along the drive shaft 108 laterally to the media path 103 in the X-direction and be adjustably disposed along an entire width of the media path 103. In other words, the cutting module 100 may be slid or translated along the drive shaft 108 to orient the cutting module 100 anywhere across the width of the media path 103 and, thus, the media 110 therein, in order to cut the media 110 to a desired width. Once positioned appropriately to cut or trim media 110 to a desired width, the cutting module 100 may cut media 110 along the media path 103, in the Y-direction. In some implementations, the cutting module 100 may be manually translated or slide, by a user, for example, along the drive shaft 108 to appropriately place the cutting module 100 to cut media to a desired width. In other implementations, another component or device, such as a translator, may move the cutting module 100 along the drive shaft 108. In some implementations, the cutting module 100 may be disposed in the media path 103 downstream from where the imaging device 101 performs an operation on media 110, such as printing, for example. In such an example, the cutting module 100 may cut the media 110 into a first portion 110a, and a second portion, 110b, prior to the media being output from the imaging device 101. In other implementations, the cutting module 100 may be disposed upstream from where the imaging device 101 performs an operation on media 110, such that the cutting module 100 may cut the media 110 prior to undergoing an imaging device operation.

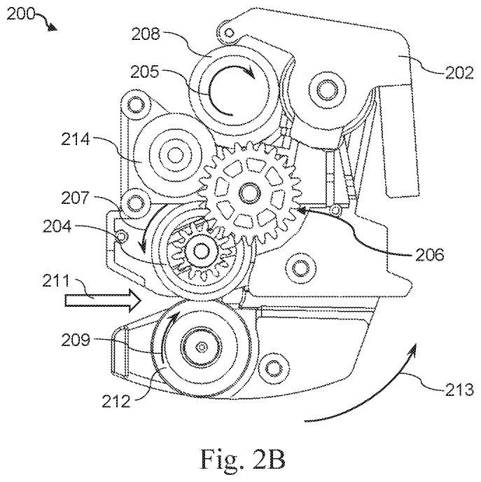

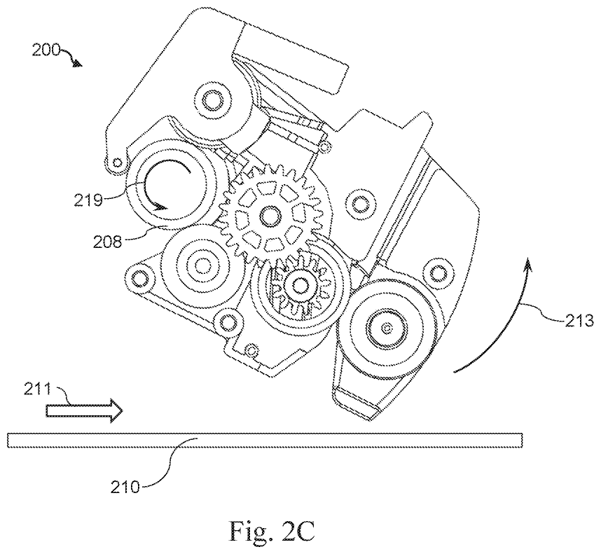

Referring now to FIGS. 2A-B, a perspective view and a side view, respectively, of an example cutting module or cutting device 200 is illustrated. Example cutting module 200 may be similar to example cutting module 100. Further, the similarly named elements of example cutting module 200 may be similar in function and/or structure to the elements of example cutting module 100, as they are described above. Example cutting module 200 may be engaged with a drive shaft 208. Drive shaft 208 may be operably engaged with a motor, transmission, or other drive mechanism to rotate the drive shaft in a first direction 205. The drive shaft 208 may be engaged with a housing 202 of the cutting module 200 such that the drive shaft 208 supports the cutting module 200. The housing 202 may include a roller or rollers such that the drive shaft 208 may rotate relative to the cutting module 200. In some implementations, the drive shaft 208 may engage with the cutting module 200 through three rotatable points of contact, such that the drive shaft 208 can fully support the cutting module 200, and still rotate relative to the cutting module 200. Further, the cutting module 200 may include a drive system 206 to drive a cutter 204 to cut media travelling through a media path 211. The drive system 206 may engage with the drive shaft 208 such that the rotation of the drive shaft 208 is transmitted to rotation of the cutter 204. More specifically, for example, rotation of the drive shaft 208 in the first direction 205 may be transmitted through a friction wheel 214, which may then transmit the rotation through a transmission, or, through a series of cogs, gears, friction wheels, or other suitable components to drive or rotate the cutter in cutting direction 207, as illustrated in FIG. 2B. In some implementations, cutting direction 207 may be the same direction as the media path 211, such that, as media is delivered through the media path 211, the cutter 204 is rotated in the same direction as the media is moving so as to cut the media. Additionally, in some implementations, drive system 206 may include suitable gear ratios or gear sizes such that the rotation of the drive shaft 208 results in the cutter 204 rotating at a suitable or adequate angular velocity so as to cut the media as it travels through the media path 211.

Further, cutting module 200 may further include a second cutter 212 to cut media travelling through the media path 211 in a direction along the media path 211. In such a situation, the cutter 204 may then be a first cutter 204. In some implementations, the second cutter 212 may be similar to the first cutter 204. In further implementations, the first and second cutters 204 and 212 may both be rotary cutters. In some implementations, the first cutter 204 and the second cutter 212 may be oriented relative to one another so as to adequately cut media within the media path 211 when the media is delivered in between the first and second cutters 204 and 212. In some implementations, the first and second cutters 204 and 212 may each have a cutting edge that overlaps with the cutting edge of the other cutter. Additionally, the second cutter 212, in some implementations, may also be driven by the drive system 206 to cut media. In other implementations, the second cutter 212 may be driven along direction 209, in the same direction as the media path 211, through contact with the media travelling through the media path 211.

Referring additionally to FIG. 2C, a side view of an example cutting module 200 is illustrated. In some implementations, media travelling through a media path of an imaging device may already be sized appropriately for the operation to be performed by the imaging device on the media. In other implementations, it may be desirable to output the media from the imaging device without cutting or trimming the media along the media path 211. In such a situation, the cutting module 200 may be adjusted, moved, or rotated out of the media path 211 of the imaging device. The cutting module 200 may be stowed such that the cutting module 200 does not cut or trim media 210 travelling through the media path 211, as illustrated in FIG. 2C. In some implementations, the cutting module 200 may be stowed by rotating about a longitudinal axis of the drive shaft 208 until the cutter 204 and/or the second cutter 212 is removed from the media path 211, and the cutting module no longer cuts media therein. In further implementations, the drive shaft 208 may rotate the cutting module 200 about the longitudinal axis of the drive shaft 208 out of the media path 211. In yet further implementations, the drive shaft 208 may rotate in a second direction opposite that of direction 205, such as direction 219, for example, in order to rotate the cutting module 200 out of the media path, for example, along direction 213. In still yet further implementations, the drive system 206 may lock when the drive shaft 208 rotates in the second direction 219, such that the rotation of the drive shaft 208 causes the housing 202 to rotate along example direction 213 until the cutter 204 is no longer disposed in the media path 211 and the cutting module 200 no longer cuts media within the media path 211.

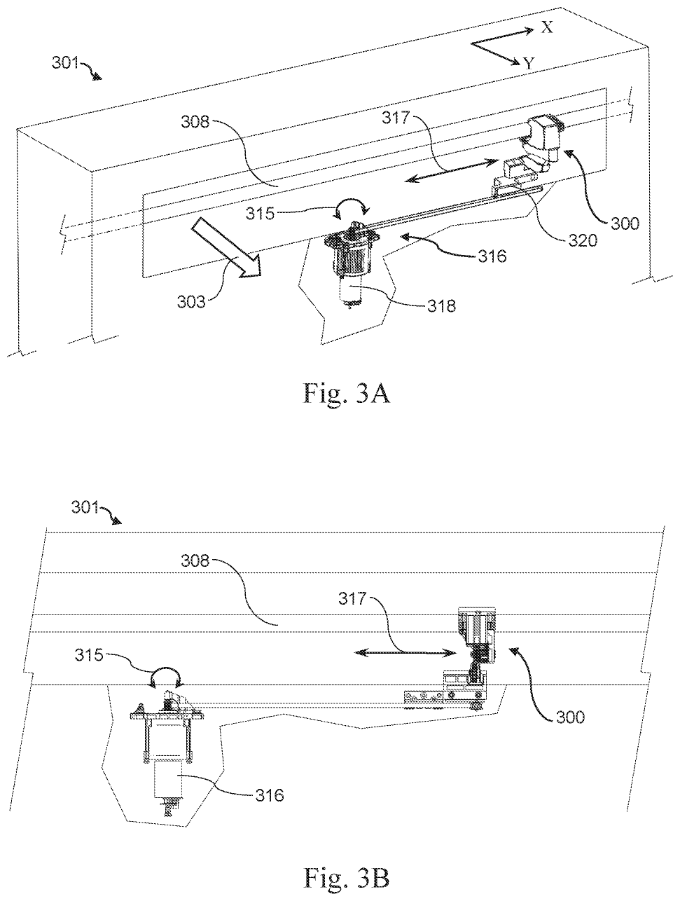

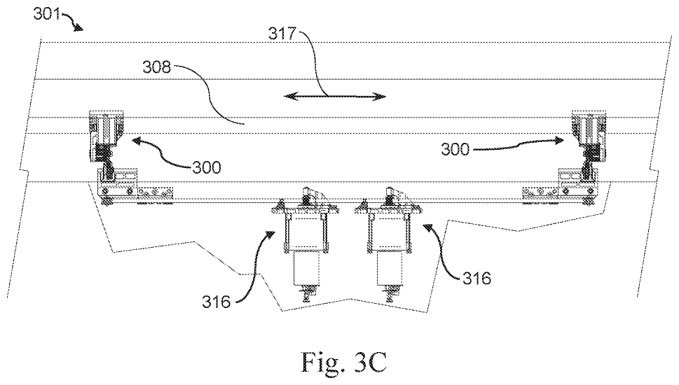

Referring now to FIGS. 3A-B, a cutaway perspective view, and a cutaway front view, respectively, of an example imaging device 301 having an example cutting system is illustrated. The example cutting system may have an example cutting module 300. The example cutting module 300, and example imaging device 301, may be similar to example cutting modules and example imaging devices described above. Further, the similarly named elements of the example cutting module 300 or example imaging device 301 may be similar in function and/or structure to the elements of example cutting modules and imaging devices described above. In some implementations, the imaging device 301, the cutting system therein, or the cutting module 300 thereof, may include a drive shaft 308, and the cutting module 300 may be adjustably disposed along the drive shaft 308 in an X-direction. In other words, the cutting module 300 may be adjusted across the X-direction in order to appropriately position the cutting module 300 to cut media moving through a media path 303 to a desired width. The media may be cut along the media path 303. In some implementations, the media path 303 may be aligned with a Y-direction, orthogonal, or perpendicular to the X-direction.

The cutting system may further include a translator 316. The translator 316 may be disposed within the imaging device 301, in some implementations, and engaged with the cutting module 300. The translator 316 may include a component or components capable of moving the cutting module 300 along the drive shaft 308 in the X-direction. Further, the translator 316 may be capable of supporting and/or adjustably fixing the cutting module 300 in position along the drive shaft 308 after the translator has moved the cutting module 300 along the drive shaft 308 to a desired position. For example, the translator 316 may include a drive component 318 and a connector 320, in some implementations. The drive component 318 may be a motive element or component that is capable of moving the connector 320 in order to adjust the position of the cutting module 300 along the X-direction. In some implementations, the drive component 318 may be a motor or other motive element. The connector 320 may be a component or components to engage the cutting module 300 with the drive component 318. For example, the connector 320 may include a cradle to interface with and receive the cutting module 300 or a portion thereof. Further, the connector 320 may include a belt, chain, or other type of drive such that the drive component 318 can move the cradle and the cutting module 300 therein along the X-direction. In other implementations, the connector 320 may include another component, such as a worm gear, or other transmission components to move the cradle, and thus the cutting module 300 along the X-direction. In further implementations, the drive element 318 may rotate, for example, in direction 315, thus pulling a belt drive engaged with the cutting module 300 along direction 317 to adjust the position of the cutting module 300. In some implementations, the drive shaft 308 may rotate in a direction to move the cutting module out of the media path such that the cutting module 300 does not cut media within the media path. In such a situation, the cutting module 300 may be removable from engagement with the translator 316, or the connector or cradle thereof, so that the cutting module 300 may rotate out of the media path and avoid cutting media therein. The cutting module 300 may be engageable or re-engageable with the translator 316, or the connector or cradle thereof, if the drive shaft 308 rotates the cutting module 300 back into the media path to cut media therein.

Referring now to FIG. 3C, a front view of an example imaging device 301 having an example cutting system is illustrated. The cutting system may include a translator and a cutting module 300. Additionally, the cutting system may include another, or a second cutting module 300, engaged with the same, or another/second translator 316. Each of the cutting modules 300 may be moved along the drive shaft 308 in example direction 317. In some implementations, each cutting module 300 may be moved by a respective translator 316 independently of the other cutting module 300. Each of the cutting modules 300 may be moved to a different location along the drive shaft 308 in the X-direction and each may cut a different portion of media in the Y-direction in order to cut the media to a desired width. In some implementations, the cutting system may include more than two cutting modules 300, each of the cutting modules 300 adjustable or movable along the drive shaft 308 in the X-direction to cut media to a desired width or multiple widths. In further implementations, the drive shaft 308 may rotate some or all of the cutting modules 300 out of the media path such that the cutting modules 300 do not cut media within the media path.

In further implementations, the imaging device 301 may include a processor and computer readable instructions stored in a memory. The instructions may include a location along the X-direction and instruction for the translator to move a cutting module 300 to that location. Further, the instructions may receive a location along the X-direction from another device. The location may be sent to the imaging device from an outside device, or may be input to the imaging device through a user interface. In some implementations, a user may instruct the imaging device to cut or trim media to a specific or desired width. In some implementations, the imaging device may automatically trim or cut the media to the width of the print area, or the area upon which an operation was performed by the media. The processor may then execute the computer readable instructions to determine the location along the X-direction to which a cutting module 300 may be moved in order to cut media to the desired width. In further implementations, the processor may execute the computer readable instructions in order to determine two different locations, each to which a separate cutting module 300 may be moved by the translator 316. Therefore, two separate cutting modules 300 may be independently moved to a different location along the X-direction so that the two cutting modules 300, together, cut or trim media to a desired width.

What is claimed is:

1. A cutting module, comprising:
a housing to engage the cutting module with a drive shaft, the cutting module to move along the drive shaft laterally to a media path of an imaging device;
a first cutter disposed in the housing; and
a drive system to drive the cutter such that the cutter cuts media along the media path.

2. The cutting module of claim 1, further comprising a second cutter to cut media along the media path.

3. The cutting module of claim 2, wherein the first and second cutters are rotary cutters.

4. The cutting module of claim 1, wherein the drive shaft is to rotate to drive the first cutter through the drive system.

5. The cutting module of claim 4, wherein the drive system comprises a transmission to operably engage the drive shaft with the first cutter.

6. A cutting module, comprising:
a drive shaft extending into a media path of an imaging device;
a housing to engage with the drive shaft to adjustably dispose the cutting module in the media path;
a first and second cutter, the drive shaft to drive at least the first cutter to cut media within the media path in a direction along the media path.

7. The cutting module of claim 6, wherein the housing is movable along the drive shaft laterally to the media path to adjustably dispose the cutting module in the media path.

8. The cutting module of claim 7, wherein a translator is to move the cutting module along the drive shaft laterally to the media path.

9. The cutting module of claim 8, wherein the imaging device comprises a processor, the processor to instruct the translator to move the cutting module along the drive shaft such that the cutting module cuts media to a desired width.

10. The cutting module of claim 6, wherein the drive shaft is to rotate the cutting module out of the media path such that the cutting module does not cut media within the media path.

11. A cutting system of an imaging device, comprising:
a drive shaft;
a cutting module, comprising:
a housing to engage the cutting module with the drive shaft so the cutting module is disposed in a media path of the imaging device; and
a cutter engaged with the drive shaft through a drive system, the drive shaft to drive the cutter to cut media moving through the media path within the imaging device.

12. The cutting system of claim 11, further comprising a translator to move the cutting module laterally to the media path of the imaging device to cut the media to an adjustable width.

13. The cutting system of claim 12, wherein the translator comprises a belt drive to translate the cutting module.

14. The cutting system of claim 12, further comprising a second cutting module to cut media within the imaging device, the translator to move the first and second cutting module laterally to the media path of the imaging device to cut the media to an adjustable width.

15. The cutting system of claim 14, wherein the drive shaft is to rotate the first and second cutting modules out of the media path such that the cutting modules do not cut media within the media path.
